(19) United States
(12) Patent Application Publication
(10) Pub. No.: US 2005/0004853 A1
(43) Pub. Date: Jan. 6, 2005

(54) Method for financing infrastructure or building initiatives

(75) Inventors: John McGregor, Edinburgh (GB); George McLean Hazel, Edinburgh (GB)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: E-RAIL LIMITED

(21) Appl. No.: 10/623,277

(22) Filed: Jul. 18, 2003

(30) Foreign Application Priority Data
Jul. 4, 2003 (GB) 0315689.0

(51) Int. Cl. G06F 17/60

(52) U.S. Cl. 705/35

(57) ABSTRACT

A method for funding infrastructure or building initiatives, such as a transport initiative, includes collecting payments from parties who stand to financially benefit from the initiative and using these payments to partly or wholly fund the initiative.

### CROSS-REFERENCE TO RELATED APPLICATION

The subject matter of this application is related to the subject matter of British Patent Application No. GB 0315689.0, filed Jul. 4, 2003, priority to which is claimed under 35 U.S.C. § 119 and which is incorporated herein by reference.

### BACKGROUND OF THE INVENTION

1. Field of the Invention

The present invention relates to a method for financing infrastructure or building initiatives, and in particular transport initiatives, such as rail, bus, guided bus, tram and road links.

2. Description of Related Art

Transport creates wealth, and this wealth can be measured. For example, it is estimated that the Jubilee Line Extension in London added about 13 billion in value to property along the extended part of the line. In Washington D.C., the new Metro is estimated to have generated about $10-15 billion. A study in Boston suggested that transport caused an up-lift in property value, which expressed as a percentage of land or property value without the transport facility represented an increase of 7%. A similar study in Philadelphia suggested that the premium there was 4-10%.

While the property value up-lift created by transport and other infrastructure facilities is tangible and can be measured, it can be difficult for the public sector to benefit from this.

### SUMMARY OF THE INVENTION

The present invention seeks to address this by using this up-lift as a mechanism for funding such initiatives. Accordingly, the present invention relates to a method for funding infrastructure or building initiatives, for example transport initiatives, the method comprising collecting payments from parties who stand to financially benefit from the initiative, and using this to fund the initiative. Preferably, the parties who stand to gain financially from the initiative include any one or more of property developers and property owners and landowners.

By collecting or receiving funds from parties such as landowners or property developers, transport or other beneficial infrastructure initiatives that might otherwise not be provided through lack of financial resources can be properly and effectively financed without an undue burden on the public purse. This has the dual advantage of helping the public sector provide transport infrastructure, which is of significant benefit to the public, while allowing the private sector the potential to capture the financial advantage that will inevitably be created by the transport initiative.

Preferably, the method involves assessing a measure of the increase in property value that is likely to be created by the provision of the transport link.

The method further involves assessing parties that may be interested in providing funds and entering confidential negotiations with those parties.

The method may involve landowners and/or property developers applying for or receiving planning permission to build or re-build property in the property up-lift area. The property up-lift area may be a pre-defined or designated area in the vicinity of the proposed new transport link. Preferably, the step of collecting money is done after planning permission is granted.

### BRIEF DESCRIPTION OF THE DRAWINGS

Various aspects of the invention will now be described by way of example only and with reference to the accompanying drawings, of which:

FIG. 1 is a flow diagram of a first stage of methodology according to an embodiment of the invention, and

FIG. 2 is a flow diagram of a second stage of methodology according to an embodiment of the invention.

### DETAILED DESCRIPTION OF PREFERRED EMBODIMENTS

The method in which the invention is embodied provides funding for transport or other infrastructure initiatives using an estimate of an increase in property values in the regions where the new initiatives are to be provided and/or savings gained by the provision of these new services. Several parties are involved in the method of the invention. First, there is the party that wishes to provide the proposed new infrastructure, for example a transport link. Typically this is a local government authority or transport operator. Also involved are landowners or property developers who may be interested in building along the route of the new transport link to take advantage of the property value up-lift or who may already have property along that route. To act as a go-between for these parties, there is also an agent.

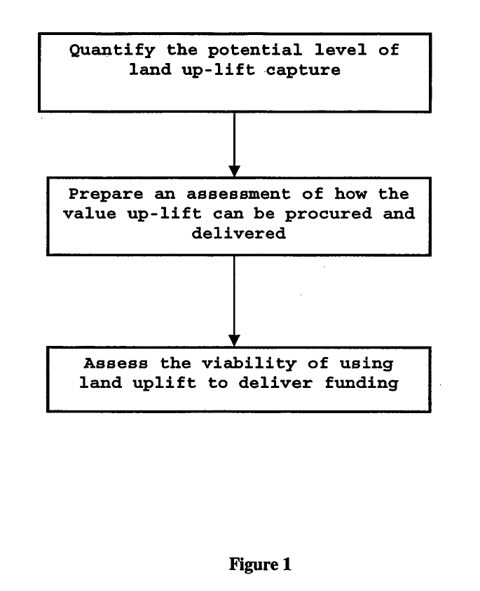

The methodology works in two stages. The steps taken in the first stage are shown in FIG. 1. First, an initial report is prepared to test the feasibility of the methodology and quantify the potential level of land uplift capture. This stage is carried out by the agent, and may be done on a fixed fee basis, which fee would usually be set out at a level that is less than that at which a local authority would require to put the work out to tender. The initial report includes a property assessment of the potential developments and a quantification of the land uplift capture. This quantification is a range based on the probability of securing planning consent. This stage also includes meetings with key local authority personnel and other probable stakeholders that might include railway companies, track owners and others involved in transportation and planning issues. The report also includes details of proposed techniques for procuring and delivering the methodology and an assessment of the land/property value uplift and/or any savings delivered by the initiative, thereby to provide funding for the initiative.

Various methods may be used to assess the up-lift value and the amount that could be contributed by the developers/land owners. For residential housing units that are near the proposed new transport facilities, the variables are the number of units, the price of each unit and the term of the agreement. As a specific example, research shows that prices housing units close to efficient and comfortable transport services attract a premium. The range is typically between 3% and 10% dependent on the actual distance to the halt and the value spread of the units. For 50 homes made up of 3 story executive flats, selling at £250,000 each, this means that the value up-lift for each unit is between £7,500 and £25,000. If the flats back onto the track, the lower range is likely to be just above 3% but the higher range will be at around 6.5%. However, if the flats do not back onto the track and are at a convenient distance therefrom, the lower range is likely to be just above 6.5% and the higher range may be 10%. In any case the up-lift value for the fifty units may be in the range £375,000 and £1,250,000. By contributing a percentage of this up-lift developers can assist with the funding of the transport link to the mutual benefit of themselves and the local community.

Similar calculations can be done to determine the up-lift in rental yields for properties near the proposed new transport link. In the case of South London offices after the Jubilee Line was introduced, rents rose from £10 per sq ft to £25 per sq ft in the space of four years. Similarly, yields at the time moved from 10% to 7½%. Of course, care must be taken when analysing these up-lifts that the changing market conditions and economic factors are adjusted for accordingly.

As a specific example of how rental rates could be affected, a speculative development of a 50,000 sq ft office building which attracts a rent of £18 per sq ft and a yield of 8½% in the absence of the new transport link, could instead benefit from a rent of £20 per sq ft and a yield of 7% with transport in place. The value without the transport link would be £10.58 m, but with it would be £14.28 m. This means that the difference, i.e. the up-lift, is £3.7 m. This difference could be divided between the property owner or developer and the body trying to set-up the link. For example, 50% could be donated to the transport fund by the developer or owner when the transport starts. A similar approach could be taken to the value of, for example, a Shopping Centre, assuming that the new transport line is close enough to make a difference.

As well as estimating the up-lift on existing properties, it is envisaged that development opportunities, when acquired subject to planning, could be financially analysed by carrying out a residual valuation. This also applies to land where no planning exists but a formula can be introduced, should circumstances change. The principal considerations for areas having development potential are the land value, £1.40 m; fees and interest for one year, £0.15 m; construction costs, £3.2 m for 40 homes; fees for professional team, set at 12%, so about £0.38 m; interest and contingencies about 10%, i.e. £0.36 m; the developers return of, 20%, about £1.10 m, and agency sale costs and advertising, which may be about 2%, £0.15 m. This results in a total cost of £6.74 m. Without the transport link the estimated cost of each unit would be £170,000, with a return of £1.1 m for the developer. However, with the transport link the 40 units would sell at £187,000. This represents an up-lift of about £680,000 that can be split equally between developer and transport provider. In this way, the developer can enjoy an additional £340,000 for no extra effort or risk, and the transport initiative can receive additional external funding.

As well as property developers, local companies may gain financially from the provision of a transport initiative because of savings that may arise. Research reveals that where there are no transport links, many companies have to provide company cars or other options to help staff to get to work. These issues carry with them additional associated costs, such as for car parking, insurance and many other associated outlays where no transport links are available. When alternative transport is introduced, savings can be made. These can be calculated and an estimate made of the value, the figure being divided in a pre-determined manner, for example halved, to arrive at a contribution. As a specific example, it has been calculated that a saving of £4,000 would be achieved for an average car. This could be split equally between parties. Similarly, the attitude to travelling to work, the time saved and improvement to quality of life, whilst difficult to calculate accurately, can be broadly assessed. On work hours saved due to improved transport arrangements, the range is estimated at 1-2 hours per week. At £8 per hour for 52 weeks for 2 years the overall saving can be estimated to be £6,656 per employee. The employer should enjoy the majority of the bonus. The agreed contribution could be for example 25%, £1500. In this way for each car that is taken off the road, an employer could contribute up to £3,500 as a one off payment.

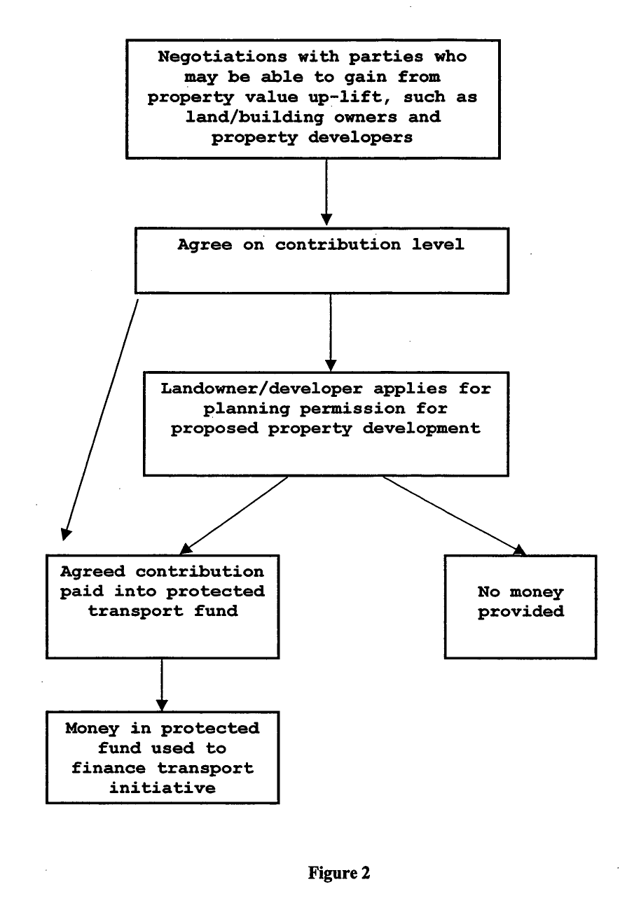

Once the initial report is drawn up, with its various estimates of the value up-lift provided by the transport initiative and a rough estimate of the amount that could be raised, the second stage is to secure the land uplift for the project, assuming that an appropriate funding vehicle has been found. The steps taken in the second stage are shown in FIG. 2. This stage involves the transport procurer appointing an agent. This may be the same agent who prepared the initial report. The agent is charged with the task of raising funds from landowners or property developers. The agent is likely to be appointed on a 100% success fee basis. Typically, this success fee is based on an agreed percentage of the money raised.

The agent sets up a protected transport fund, which can only be accessed by the agent and the transport procurer. The agent then enters into confidential negotiations with each relevant landowner and/or potential developer or indeed anyone within the area effected by the transport, who stands to gain financially as a result of the transport initiative and seeks to reach an agreement on the level of contribution to be paid into the protected fund. This agreement takes the form of a legal document, which for land or property deals may optionally be built into the title of the land or property. Typically this is a bespoke agreement depending on the status of, for example, the land or buildings. The agreed contribution is paid when the landowner/developer either gains outline planning consent for the proposed development or the asset has increased in value and there is a legally secure commitment to construct the transport facility. If no transport is delivered then the money will automatically be returned.

Where appropriate, the landowner/developer independently applies for planning consent for the development associated with their land or project. As each application for planning permission is granted, providing the legal agreement for the transport facility is in place, the landowner/developer pays the agreed contribution into the protected fund. The key to maximizing the capture of the uplift is to ensure each landowner/developer receives a fair return. The agent receives the agreed percentage of money raised as each contribution is paid. The agent's role ends once all contributions have been received. In this way, local authorities can feedback some of the financial benefit provided by enhanced transport capabilities into the fund for financing those capabilities.

An advantage of the methodology in which the invention is embodied is that it is separate from the planning permission process. Each landowner/developer applies independently for his/her individual planning consents. In addition, the methodology is led by the initiative that is to be funded, i.e. the sole reason is to deliver that project, for example a transport initiative, not individual developments. It uses sustainable development around the transport facility to help fund the capital and potentially some of the operational costs of the transport facility. The fact that additional patronage comes from the surrounding development, increasing the revenue stream, is an added bonus. The methodology also addresses the issue of multiple ownership.

A further advantage of the invention is that no direct payment is needed from any party in order to maintain its impartiality. The agent's fee may come from an agreed percentage of the land value uplift captured for the project. This means that there is no downside for either the public or private sector. The public sector does not pay any professional fees up front and the private sector does not have to pay a contribution until planning consent is received and there is a legally binding agreement that the transport facility will be built. Each contribution agreement is tied to a legal document built into the title of the land. A further advantage is that the methodology adheres to procurement and best value processes in the UK.

A skilled person will appreciate that variations of the disclosed arrangements are possible without departing from the invention. For example, while the invention is described primarily with reference to rail initiatives, it will be appreciated, that it could equally be applied to other types of infrastructure or building initiatives. In addition, although some specific examples of how the up-lift value may be calculated are provided, in practice it may be that a combination of available methods will be used to maximize the funding opportunities. Accordingly, the above description of the specific embodiment is made by way of example only and not for the purposes of limitation. It will be clear to the skilled person that minor modifications may be made without significant changes to the operation described.

1. A method for funding an infrastructure or building initiative, the method comprising collecting payments from parties who stand to financially benefit from the initiative and using these payments to partly or wholly fund the initiative.

2. A method as claimed in claim 1 involving assessing a measure of an increase in property value that is created by provision of the initiative.

3. A method as claimed in claim 2, wherein each payment collected is a percentage of the assessed increase in value.

4. A method as claimed in claim 1 further involving assessing a measure of savings made by provision of the initiative.

5. A method as claimed in claim 2 further involving assessing a measure of savings made by provision of the initiative.

6. A method as claimed in claim 3 further involving assessing a measure of savings made by provision of the initiative.

7. A method as claimed in claim 4, wherein each payment collected is a percentage of the assessed savings.

8. A method as claimed in claim 1 further involving assessing parties that may be interested in providing funds and entering confidential negotiations with those parties.

9. A method as claimed in claim 1 further involving applying for or granting planning permission to build or re-build property in a property up-lift area.

10. A method as claimed in claim 9, wherein the property up-lift area is a pre-defined or designated area in a vicinity of the initiative.

11. A method as claimed in claim 1 wherein the step of collecting payments is done after planning permission is granted to a property developer and the initiative is committed.

12. A method as claimed in claim 1 wherein the parties who stand to financially benefit include landowners and/or developers and/or companies.

13. A method as claimed in claim 1 wherein the initiative is a transport initiative.

14. A method as claimed in claim 3 wherein the percentage is a pre-determined percentage.

15. A method as claimed in claim 7 wherein the percentage is a pre-determined percentage.
